(19) United States
(12) Patent Application Publication
(10) Pub. No.: US 2011/0236643 A1
(43) Pub. Date: Sep. 29, 2011

(54) DISPLAY MODULE AND METHOD OF MANUFACTURING DISPLAY MODULE

(76) Inventors: Mikihiko Tsubouchi, Chiba (JP); Satoshi Kurono, Aihi (JP); Tsuyoshi Yamamoto, Aichi (JP); Takeshi Katoh, Mie (JP)

(21) Appl. No.: 13/130,793

(22) PCT Filed: Nov. 18, 2009
(86) PCT No.: PCT/JP2009/069547

§ 371 Date: May 24, 2011

(30) Foreign Application Priority Data
Nov. 27, 2008 (JP) 2008-302391

(51) Int. Cl. C09K 19/00; B32B 37/12

(52) U.S. Cl. 428/192; 156/273.3

(57) ABSTRACT

There is provided a display module comprising: a first component; a second component; and an adhesive layer formed between the first component and second component and in an outer peripheral area of both components, wherein the first component and second component are connected by the adhesive strength of the adhesive layer, and a closed space is formed by the first component, the second component and the adhesive layer, wherein the adhesive layer is made of a photo-curable adhesive resin composition which is cured and activates adhesiveness when irradiated with a light and sustains the adhesiveness, and the adhesive layer has such a thickness as to have translucency which allows the photo-curable adhesive resin composition to be cured with irradiation of a light from the direction between the first component and second component, and has such a width as to have a substantial light shielding property against transmission of a light in the adhesive layer in the direction between the closed space and an exterior of the display module.

### TECHNICAL FIELD

The present invention relates to a display module configured such that a plurality of display components (for example, a panel and unit) are connected together, and a method of manufacturing such display module.

### BACKGROUND ART

In recent years, various display modules including a liquid crystal type display module have been widely used. Among the display modules, there is known a liquid crystal type display module which is assembled by connecting a liquid crystal panel and a back light unit using a double-sided tape which has a function of shielding a light. Further, a display module whose rework efficiency is enhanced by restraining the adhesive strength of the double-sided tape is proposed (see, for example, Patent Literature 1).
[Patent Literature 1] Japanese Patent Application Laid-Open No. 2006-106417

### DISCLOSURE OF THE INVENTION

### Problems to be Solved by the Invention

The display module described in Patent Literature 1 is configured to have the adhesive strength of the double-sided tape set to a specified value or less so that re-separation of the liquid crystal panel and back light unit adhered together is made easier, thereby enabling improvement of the rework efficiency and reducing the recovery cost.

However, at the initial manufacture stage, it is necessary to punch out a sheet-like double-sided tape according to the peripheral shapes of the components (for example, a panel, unit) to be adhered together, so that the center portion of the punched-out sheet is wasted, thereby reducing the yield as in the related art. Further, it is necessary to carry out a very troublesome assembly work such as removing one of the separators of the double-sided tape, and sticking one side of the double-sided tape onto one panel, then removing the other separator and sticking the other side of the double-sided tape onto the other panel, thereby raising the problem of reducing the manufacturing efficiency and increasing the manufacturing cost as in the related art.

When the sticking positions of the double-sided tape are inaccurate, the bonding strength of the panels also becomes lower, which may raise a problem such as light leaking or the like. Furthermore, since there are many human-attending processes, it will cause many troubles originated by mixture of foreign matters.

Therefore, an object of the present invention is, with solving the above-mentioned problems, to provide a display module, which can easily and efficiently perform a work for connecting the components constituting the display module, and provides light shielding function between the inner space of the display module and the outside thereof, and a method of manufacturing such display module.

### Means for Solving the Problems

To overcome the above-mentioned problems, one aspect of a display module according to the invention is a display module comprising: a first component; a second component; and an adhesive layer formed between the first component and second component and in an outer peripheral area of both components, wherein the first component and second component are connected by the adhesive strength of the adhesive layer, and a closed space is formed by the first component, the second component and the adhesive layer, wherein the adhesive layer is made of a photo-curable adhesive resin composition which is cured and activates adhesiveness when irradiated with a light and sustains the adhesiveness, and the adhesive layer has such a thickness as to have translucency which allows the photo-curable adhesive resin composition to be cured with irradiation of a light from the direction between the first component and second component, and has such a width as to have a substantial light shielding property against transmission of a light in the adhesive layer in the direction between the closed space and an exterior of the display module.

According to this aspect, as compared with the case where the conventional adhesive tape or the like is used, a finer adhesive layer having a higher degree of freedom of design can be formed efficiently with a higher yield without involving a complicated work by applying an uncured liquefied photo-curable adhesive resin composition to a component.

Since the use of the photo-curable adhesive resin composition can complete connecting components quickly at normal temperature without requiring drying or heating, the working efficiency is improved as compared with the case where a conventional solvent type adhesive, water type adhesive, or hot-melting adhesive is used. Since the adhesive strength is sustained after the photo-curable adhesive resin composition is cured by light-irradiation, connecting work of the components can be carried out separately from the light irradiation process, and it is easier to handle the components, thus improving the working efficiency, as compared with the case where the conventional photo-curable adhesive resin is used.

Further, according to adequate selection of the thickness and width of the adhesive layer, the contradictory performances by nature, namely the translucency enough to cure the uncured photo-curable adhesive resin and the substantial light shielding property that does not cause a problem in practical use of the display module, at the same time.

According to the aspect, as described above, the work of connecting the components of the display module can be carried out easily and efficiently, so that the display module which has the function of shielding a light between the inner space of the display module and the outside thereof can be provided at a low manufacturing cost.

Another aspect of the display module according to the invention is the display module, wherein the first component and the second component do not have translucency enough to cure the uncured photo-curable adhesive resin composition existing between the first component and the second component with irradiation of a light from outside the components.

In the case of using the conventional photo-curing adhesive, unless at least one of the first component and the second component has the translucency which cures the adhesives existing between both components with irradiation of a light from the outside of the components, both components cannot be adhered. According to the aspect, the adhesive strength of the adhesive layer is maintained even after light irradiation ends, so that even when both components do not have the translucency, it is possible to form an adhesive layer by directly irradiating a light to the photo-curable adhesive resin composition applied to one component, and easily connect both components after light irradiation is ended.

Another aspect of the display module according to the invention is the display module, wherein the adhesive layer has elasticity, and the closed space is sealed from outside by the adhesive layer.

Since the adhesive layer has elasticity according to this aspect, the adhesive layer can be used as a seal member. Therefore, external dust, humidity or the like can be prevented from entering the interior of the display module (closed space) beforehand.

Another aspect of the display module according to the invention is the display module, wherein having the substantial light shielding property means having an optical density of 3 or more in terms of an OD (Optical Density) value.

As the adhesive layer has an optical density of 3 or more in teens of the OD value according to the aspect, it can have a sufficient light shielding effect for practical use of the display module.

Another aspect of the display module according to the invention is the display module, wherein reflectance of the adhesive layer with respect to light which travels in the direction between the closed space and the exterior of the display module is 0.5% or less.

If the adhesive layer has a sufficient light shielding effect, it is possible to prevent light inside the display module from leaking or prevent external light from entering the interior of the display module. When reflectance is high, however, a light generated inside the display module like back light, for example, may be reflected inside the display module, thereby interfering with uniform light irradiation toward the display surface. Accordingly, providing a low reflectance according to the aspect can achieve prevention of light leakage and uniform illumination at the same time.

Another aspect of the display module according to the invention is the display module, wherein the first component is a back light unit, and the second component is a liquid crystal panel.

This aspect can provide the liquid crystal type display module which has the aforementioned operational effect.

Another aspect of the display module according to the invention is the display module, wherein the back light unit includes a bezel which accommodates a sheet member constituting the back light unit, and the adhesive layer is formed between a connecting surface provided on the bezel, and the liquid crystal panel.

Since the components of the back light unit can be protected appropriately, and arranged efficiently by using the bezel, and further, the adhesive layer is formed between the bezel and the liquid crystal panel, both components can be connected certainly without affecting the components of the back light unit.

Another aspect of the display module according to the invention is the display module, wherein an outer edge of the bezel extends above the liquid crystal panel, and the liquid crystal panel is accommodated in the bezel.

Since not only the components of the back light unit but also the liquid crystal panel is accommodated in the bezel according to this aspect, it is possible to achieve the compact display module in which the components are efficiently arranged in the bezel.

Another aspect of the display module according to the invention is the display module, wherein a light shielding layer made of the photo-curable adhesive resin composition is also formed on an outer peripheral area of the liquid crystal panel.

According to this aspect, the light shielding layer made of a photo-curable adhesive resin composition can effectively prevent the illumination from the back light unit from leaking from the outer peripheral area of the liquid crystal panel outside the display surface, thus providing the liquid crystal type display module which ensures clear and high-contrast display.

When the liquid crystal panel is configured to have a plurality of substrates to be connected, those substrates can also be functioned as a sealant which enables connection while maintaining the sealed state.

One aspect of the method of manufacturing a display module comprising, a first step of applying an uncured photo-curable adhesive resin composition, which is cured and activates adhesiveness when irradiated with a light and sustains the adhesiveness, to an outer peripheral area of one component; a second step of irradiating a light onto the applied photo-curable adhesive resin composition to cure the photo-curable resin composition to form an adhesive layer having an adhesive strength; and a third step of connecting another component to the side of the one component where the adhesive layer is formed, after irradiation of the light, thereby assembling the display module.

According to this aspect, as mentioned above, as compared with the case of using an adhesive tape, an adhesive layer is finer and has a higher degree of freedom of design can be formed efficiently with a higher yield without involving a complicated work, so that the degree of freedom for handling is increased to improve the working efficiency as compared with the case of using an ordinary adhesive.

Even when both components to be connected do not have translucency, both components can be connected easily, and the work of connecting the components of the display module can be carried out easily and efficiently, thereby making it possible to provide a display module which has an effect of sufficiently shielding a light between the inner space of the display module and the outside thereof at a low manufacturing cost.

### Effect of the Invention

According to the invention, as described above, the use of the photo-curable adhesive resin composition can form an adhesive layer which is finer and has a higher degree of freedom of design efficiently with a higher yield without involving a complicated work as compared with the case of using an adhesive tape, so that the degree of freedom for handling is increased to improve the working efficiency as compared with the case of using an ordinary adhesive.

Further, adequately selecting the thickness and width of the adhesive layer can provide the contradictory performances in the first place, namely the translucency enough to cure the uncured photo-curable adhesive resin and the substantial light shielding property that does not cause a problem in practical use of on the display module, at the same time, and can allow the work of connecting the components of the display module to be carried out easily and efficiently, so that the display module which has the function of shielding a light between the inner space of the display module and the outside thereof can be provided at a low manufacturing cost.

### BRIEF DESCRIPTION OF THE DRAWINGS

FIG. 1 is a cross-sectional view exemplarily showing one embodiment of the configuration of a display module according to the invention.

FIG. 2 is a side sectional view exemplarily showing one embodiment of a method of manufacturing the display module according to the invention.

FIG. 3 is a side sectional view exemplarily showing a first embodiment of the configuration of a liquid crystal type display module according to the invention.

FIG. 4 is a side sectional view exemplarily showing a second embodiment of the configuration of the liquid crystal type display module according to the invention.

FIG. 5 is a side sectional view exemplarily showing a third embodiment of the configuration of the liquid crystal type display module according to the invention.

FIG. 6 is a side sectional view exemplarily showing a fourth embodiment of the configuration of the liquid crystal type display module according to the invention.

FIG. 7 is a side sectional view exemplarily showing a fifth embodiment of the configuration of the liquid crystal type display module according to the invention.

FIG. 8 is a side sectional view exemplarily showing the problem that arises when a photo-curable adhesive resin composition is applied to a seat part having a stepwise level difference.

FIG. 9 is a side sectional view exemplarily showing the configuration for solving the problem shown in FIG. 8.

FIG. 10 is a graph showing the relation between the thickness of an adhesive layer made of a photo-curable adhesive resin composition and the transmissivity of a light.

FIG. 11 is a graph showing the relation between the wavelength of light and the transmissivity, and the relation between the wavelength of light and the reflectance when a light absorbing material is added to the photo-curable adhesive resin composition and when a light absorbing material is not added to the photo-curable adhesive resin composition.

FIG. 12 is a graph showing the relation between the additive amount of the light absorbing material (the additive amount of the light reflecting material is fixed) to the photo-curable adhesive resin composition, and the maximum depth of the photo-curable adhesive resin composition which can be cured by light irradiation.

### EMBODIMENT OF CARRYING OUT THE INVENTION

Embodiments of a display module according to the invention and a method of manufacturing this display module will be described in detail below referring to the accompanying drawings.

### Explanation of One Embodiment of the Configuration of the Display Module According to the Invention

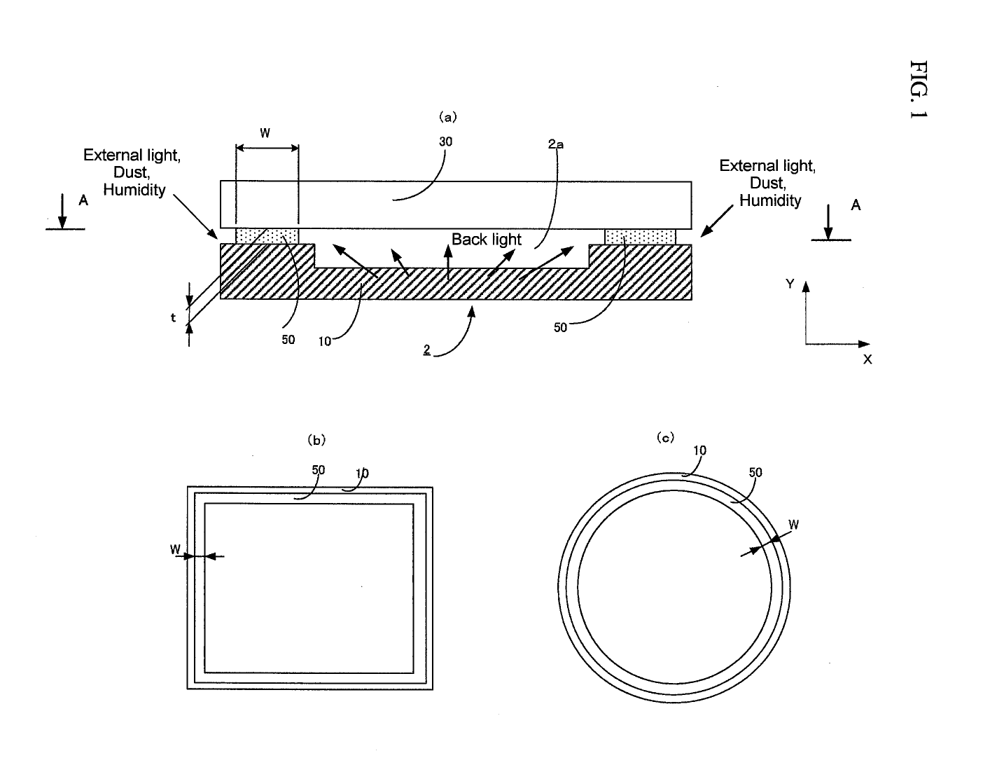

First, referring to FIG. 1, one embodiment of the configuration of the display module according to the invention will be described. FIG. 1A is a side sectional view exemplarily showing a display module 2, and FIGS. 1B and 1C are planar sectional views seen from arrow A-A in FIG. 1A.

The display module 2 shown in FIG. 1A is a liquid crystal display module as an example, which mainly comprises a back light unit (first component) 10, a liquid crystal panel (second component) 30, and an adhesive layer 50 formed between the back light unit 10 and the liquid crystal panel 30 in the outer peripheral area of both components. The back light unit 10 and the liquid crystal panel 30 are connected by the adhesive strength of the adhesive layer 50, thereby forming the display module 2. The back light unit 10, the liquid crystal panel 30, and the adhesive layer 50 form an internal region 2a of the display module 2 which is a closed space.

This adhesive layer 50 is made of photo-curable adhesive resin composition which is cured with irradiation of a light, and activates adhesiveness which is sustained. As will be described later, a liquefied photo-curable adhesive resin composition is applied to the peripheral region of one component (for example, back light unit 10), and is cured and caused to activate adhesiveness with irradiation of a light, thus forming the adhesive layer 50, and assembly is performed by connecting one component to the other component (for example, liquid crystal panel 30) with the sustained adhesive strength of the adhesive layer 50. An ultraviolet ray light or a light in visible range can be exemplified as a light to be irradiated.

The cured photo-curable adhesive resin composition also has elasticity, and can connect the back light unit 10 and the liquid crystal panel 30 in a sealed state. For this reason, dust, humidity or the like outside the display module 2 can be prevented from entering the internal region 2a of the display module 2.

When the liquid crystal panel and the back light unit are connected together using the conventional photo-curing adhesives, it is necessary to be configured such that at least one of the components is formed with a material with translucency, and a light is irradiated from outside the translucent component, in a condition that an uncured photo-curing adhesives exists between both components, to cure the photo-curing adhesives to connect the both components. Therefore, when both components do not have translucency, both components cannot be connected using the photo-curing adhesive.

On the other hand, the photo-curable adhesive resin composition used in this embodiment has the feature that the activated adhesiveness is sustained even after the composition is cured with irradiation of light. Therefore, even in a case where both components do not have translucency, it is possible to apply an uncured liquefied photo-curable adhesive resin composition to one component, irradiate a light on the applied photo-curable adhesive resin composition to be cured and activate adhesiveness to form the adhesive layer, and connect the other component after the light irradiation using the sustained adhesive strength of the adhesive layer.

Selecting an adequate value for the adhesive strength of the adhesive layer 50 can allow the back light unit 10 and the liquid crystal panel 30 to be re-separated easily while providing a sufficient bonding strength, thus increasing the working efficiency at the time of repairing or recovering the display module.

Here, the photo-curable adhesive resin composition contains a photo-curable adhesive resin and a tackifier, so that irradiation of a light cures the photo-curable adhesive resin composition and causes the composition to activate adhesiveness which will be sustained. An acrylic modified resin and an epoxy resin can be exemplified as the photo-curable adhesive resin, and acrylic tackifier, a silicone tackifier, a maleimide tackifier, a rosin ester tackifier, a terpene tackifier, a rubber tackifier, and an aromatic hydrogenated petroleum-based tackifier can be exemplified as the tackifier. As will be described later, to provide the photo-curable adhesive resin composition with a predetermined light shielding capability, the photo-curable adhesive resin composition further contains a light absorption material or a light reflecting material.

Next, explanation of FIGS. 1B and 1C which are planar sectional views seen from arrow A-A in FIG. 1A will be given. FIGS. 1B and 1C show planar shapes where the adhesive layer 50 is arranged in the outer peripheral area of the back light unit 10, in particular, FIG. 1B shows a case where the back light unit 10 has an approximately rectangular planar shape while FIG. 1C shows a case where the back light unit 10 has an approximately circular planar shape.

In either case, the adhesive layer 50 is continued over the entire perimeter of the back light unit 10, and the internal region 2a of the display module 2 and the external region of the display module 2 are separated by the adhesive layer 50.

For the display module 2 to achieve a clear display with high contrast, the light (back light) produced in the internal region 2a of the display module 2 should be prevented from leaking outside through regions other than the display surface. Correspondingly, an external light should be prevented from entering the internal region 2a of the display module 2 through portions other than the display surface.

While neither the back light unit 10 nor the liquid crystal panel 30 has translucency, as mentioned above, the adhesive layer 50 which connects the back light unit 10 and the liquid crystal panel 30 should also have a substantial light shielding property good enough to prevent a problem in practical use of the display module.

Accordingly, the photo-curable adhesive resin composition which constitutes the adhesive layer 50 contains the light absorbing material and the light reflecting material, and the adhesive layer 50 has a predetermined light shielding property according to its size.

Examples of the light absorbing material used in this embodiment can be black pigments, such as carbon black, and examples of the light reflecting material can be alumina, talc, titanium or the like.

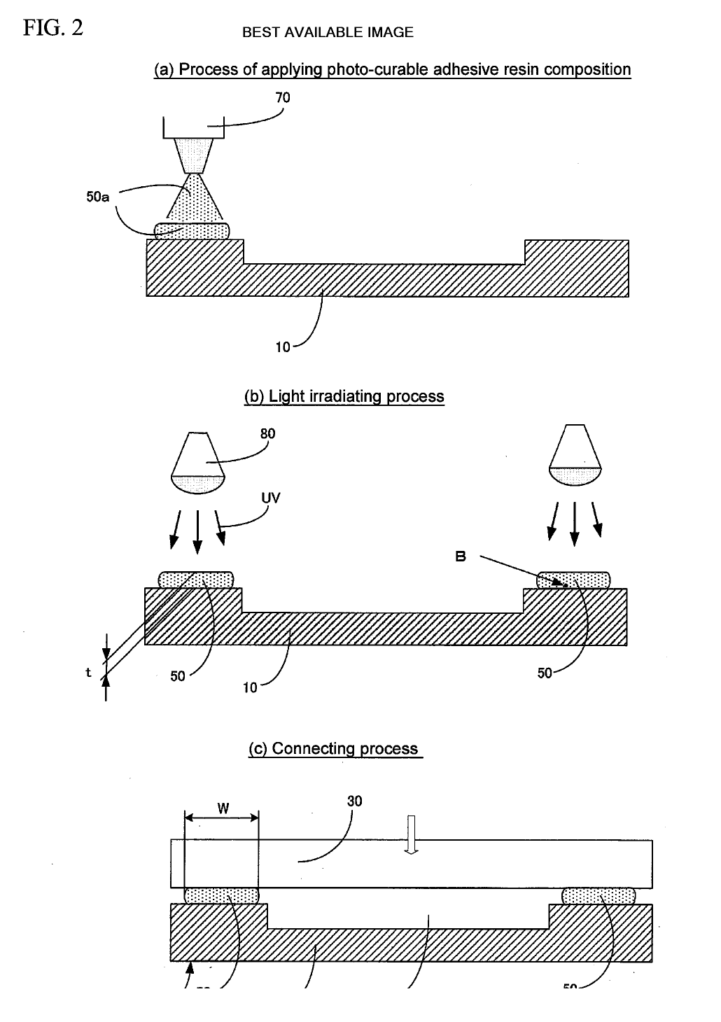

Since the photo-curable adhesive resin composition needs to be irradiated with a light to be cured to form an adhesive layer, as mentioned above, the thickness which is the dimension in the direction where the back light unit 10 and the liquid crystal panel 30 are coupled (that is, between the back light unit 10 and the liquid crystal panel 30) should provide such translucency which allows the uncured photo-curable adhesive resin composition to be cured to activate adhesiveness by irradiation of a light even at the deepest portion thereof (see arrow B in FIG. 2B). The width W which is the dimension in the direction where the internal region 2a and the exterior thereof are coupled (that is, between the internal region 2a and the exterior thereof) should provide such a light shielding property good enough to prevent a problem in practical use of the display module, as mentioned above.

That is, the adhesive layer 50 should have the contradictory performances by nature, namely the translucency and the light shielding property, which are achieved by setting the width W larger than the thickness t in the embodiment.

The foregoing will be further described in detail. A photo-curable adhesive resin composition will be cured by the radical reaction that is caused by light irradiation. According to propagation of this radical reaction, the curing is achieved to a predetermined depth in the layer in which a light does not reach. That is, as a light enters the photo-curable adhesive resin composition and the depth of the light progress increases, the transmissivity of light is decreased, and when the light reaches the predetermined depth, the transmissivity becomes substantially 0 (the measurement of a measuring instrument becomes 0). However, the propagation of the radical reaction causes the curing of the photo-curable adhesive resin composition of the deeper portion beyond the depth where the transmissivity has become substantially 0.

According to the test results as given below, the propagation of the radical reaction causes the curing of the photo-curable adhesive resin composition located 200 μm deeper than the point where a light has not substantially transmitted. For example, when the transmissivity becomes substantially 0 (an OD value is infinity) at the depth of 100 μm, the photo-curable adhesive resin composition is cured to the depth of about 300 μm. That is, for a photo-curable adhesive resin composition in which transmissivity becomes substantially 0 (the OD value is infinity) at the depth of 100 μm, about 300 μm can be exemplified as the thickness t.

Further, in consideration of the case of using a light of an arbitrary wavelength from the ultraviolet-rays range to the visible range, and the sealing effect between the back light unit 10 and the liquid crystal module 30 (i.e., elasticity of the cured photo-curable adhesive resin composition), the thickness of 200 μm or less is preferred.

An arbitrary dimension can be used for the minimum thickness t, which can be 10 μm or greater as an example in consideration of the adhesive strength and the sealing effect.

In addition, the transmissivity of 0.1 to 0.001% (3-5 in terms of the OD value) can be exemplified as the function of shielding a light (substantial light shielding) with the level which does not raise a problem for practical use of the display module. When the same photo-curable adhesive resin composition as mentioned above is used, the width W of the adhesive layer 50 corresponding to the exemplified case can be 300 μm or greater as an example. With the width of 500 μm or greater, a greater light shielding effect is acquired. An arbitrary dimension can be used for the maximum width W, which can be 1 to 2 μm or less as an example in consideration of the practical use of the display module.

The relation between OD which is the OD value and T which is the transmissivity (% as the unit) can be expressed by OD=log₁₀(100/T).

Reflection of a light contributes to light shielding. However, in case where the reflectance of the adhesive layer 50 is high, when the light produced in the internal region 2a of the display module 2 is reflected at the adhesive layer 50, reflection in the internal region 2a will take place, and interferes with uniform illumination on the whole display surface. In this respect, it is preferred, for example, to limit the reflectance of the adhesive layer 50 to 0.5% or less.

In order to reduce the reflectance while maintaining the function shielding alight, addition of a light absorbing material is effective; for example, adding the material by several % with respect to the entire weight % can reduce the reflectance significantly.

The above-described embodiment, which is the liquid crystal type display module, is not restricted to this type, and the invention can be applied to any of other display modules including an organic EL type display module and an electrophoresis type display module.

### Explanation of One Embodiment of the Method of Manufacturing the Display Module According to the Invention

Next, one embodiment of the method of manufacturing the display module according to the invention will be described referring to FIG. 2. FIG. 2 is a side sectional view exemplarily showing each process of the method for manufacturing the display module 2.

### <Process of Applying a Photo-Curable Adhesive Resin Composition>

First, as shown in FIG. 2A, an uncured liquefied photo-curable adhesive resin composition 50a is applied to the peripheral region of the display-side surface of the back light unit 10 using a dispenser 70. According to this embodiment, since the liquefied photo-curable adhesive resin composition 50a which is uncured is applied, a finer shape can easily be provided so that a good-looking result can be expected.

The composition is applied using the dispenser 70 in this embodiment, which is not restrictive, and when the back light unit 10 has an approximately flat plate shape, for example, the layer of the liquefied photo-curable adhesive resin composition 50a can be formed on the peripheral region of the back light unit 10 by various printing techniques including screen printing, offset printing, flexographic printing and gravure printing, or transfer.

For example, when the photo-curable adhesive resin composition 50a is applied by screen printing, an applied membrane of a uniform thickness and uniform width can be formed easily. In addition, multiple adherends can be applied at a time, thereby improving the working efficiency. Further, the formation of a micro pattern, such as micro line patterning, can be achieved, which is effective in the case where an applicable region is narrow.

### <Description of an Optical Irradiation Process>

Next, the layer of the liquefied photo-curable adhesive resin composition 50a applied to the back light unit 10 is irradiated with a light. The depth t of this layer is set to the dimension which the layer has the translucency which causes the photo-curable adhesive resin composition 50a to be curable at the deepest part (see arrow B) of the layer as mentioned above.

According to this embodiment, an ultraviolet light is used as an irradiation light, and the photo-curable adhesive resin composition 50a, is irradiated by an ultraviolet-ray irradiating device 80 to be cured and at the same time the adhesive strength is activated, thereby forming the adhesive layer 50. The irradiation of ultraviolet light provides the photo-curable adhesive resin composition with adhesiveness which is sustained after the irradiation of ultraviolet rays ends, so that the work of connecting the components can be carried out in a later process. Further, the cured adhesive layer 50 also has elasticity.

A conveyor type irradiating device, a spot type irradiating device, and a direct type irradiating device can be exemplified as the ultraviolet-ray irradiating device 80, and a metal halide lamp, a high-pressure mercury lamp, and an LED (Light Emitting Diode) can be exemplified as its light source.

Depending on the photo-curable adhesive resin composition, the composition can be cured and provided with adhesiveness using a visible light, not an ultraviolet light.

### <Description of the Connecting Process>

Next, the liquid crystal panel 30 is moved downward (see the arrow in FIG. 2C) from above the back light unit 10 which has the adhesive layer 50 formed in the peripheral region, the peripheral region of the bottom surface of the liquid crystal panel 30 and the upper surface of the adhesive layer 50 are made in contact with each other to connect the back light unit 10 and the liquid crystal panel 30, thereby assembling the display module 2. As a result, the internal region 2a of the display module surrounded by the back light unit 10, the liquid crystal panel 30, and the adhesive layer 50 is formed, and is in the sealed condition from the outside. The internal region 2a is substantially shielded against a light from the outside by appropriately setting the width dimension W of the adhesive layer 50 as mentioned above.

<Comparison with the Case the Conventional Adhesive Tapes or Adhesives are Used>

Next, the case where a photo-curable adhesive resin composition is used as a material to connect both components, is compared with the case where the conventional adhesive tape and adhesives are used as the material.

When the photo-curable adhesive resin composition is used, as compared with the case where the conventional adhesive tape is used, the yield loss of the material is controlled significantly and the adhesive layer which is finer and has a higher degree of freedom for design can be formed efficiently without involving a complicated work.

As the case where the conventional adhesives is used, a solvent type adhesive, water type adhesive, or hot-melting adhesive may be used.

When the solvent type adhesive or water type adhesive is used, the heat and time to dry a solvent are required, and it causes the problem that the adhesives soaks to disturb the shape of the adhesive layer during the drying. For this reason, the adhesive is applied to a mold releasing film or the like and dried, after that, the film is punched out and cut out in slits before adhesion. Therefore, the connecting work takes many steps, and the manufacturing cost for the display module increases. Although there are some solvent type adhesives which can be applied in a pattern, the application targets are limited to flat types, which restrict the actually applicable cases.

When the hot-melting adhesive is used, it is applied while being heated, so that the adhesive cannot be applied to a component with low heat resistance, and it is difficult to apply a slight amount of the adhesives.

In case of using the photo-curable adhesive resin composition, on the other hand, the liquefied composition of normal temperature can be directly applied to the adherend, and the photo-curable adhesive resin composition can be applied to a variety of compositions including a component susceptible to heat, and a fine shape can be realized easily.

In case of using a photo-curable adhesive, since connection of the components can be completed quickly at normal temperature, and without requiring the time for drying, the working efficiency improves as compared with the case where the solvent type adhesive, water type adhesive, or hot-melting adhesive is used. However, since the conventional photo-curable adhesive activates the adhesive strength only when it is cured with light irradiation, it is necessary to set up both components before curing the adhesive, and to irradiate a light from outside the components to cure the adhesive present existing between both components to connect both components. Therefore, at least one of the components must have translucency, otherwise the conventional photo-curable adhesive cannot be applied.

On the other hand, since the adhesive strength of the photo-curable adhesive resin composition activated by the light irradiation is sustained even after the end of light irradiation, it is possible to irradiate a light directly onto the photo-curable adhesive resin composition, applied to one component, in the condition that both components are separated from each other, and then connect both components easily. Therefore, both components need not have translucency.

As mentioned above, according to the use of the photo-curable adhesive resin composition, the work of connecting the components constituting the display module can be performed easily and efficiently. Further, the display module whose inner space is sufficiently shielded against a light and sealed from the outside can be provided at a low manufacturing cost by addition of the appropriate light absorbing material and appropriate light reflecting material and selection of the appropriate depth t and width dimension W of the adhesive layer.

### Description of Other Embodiments of the Configuration of the Display Module According to the Invention

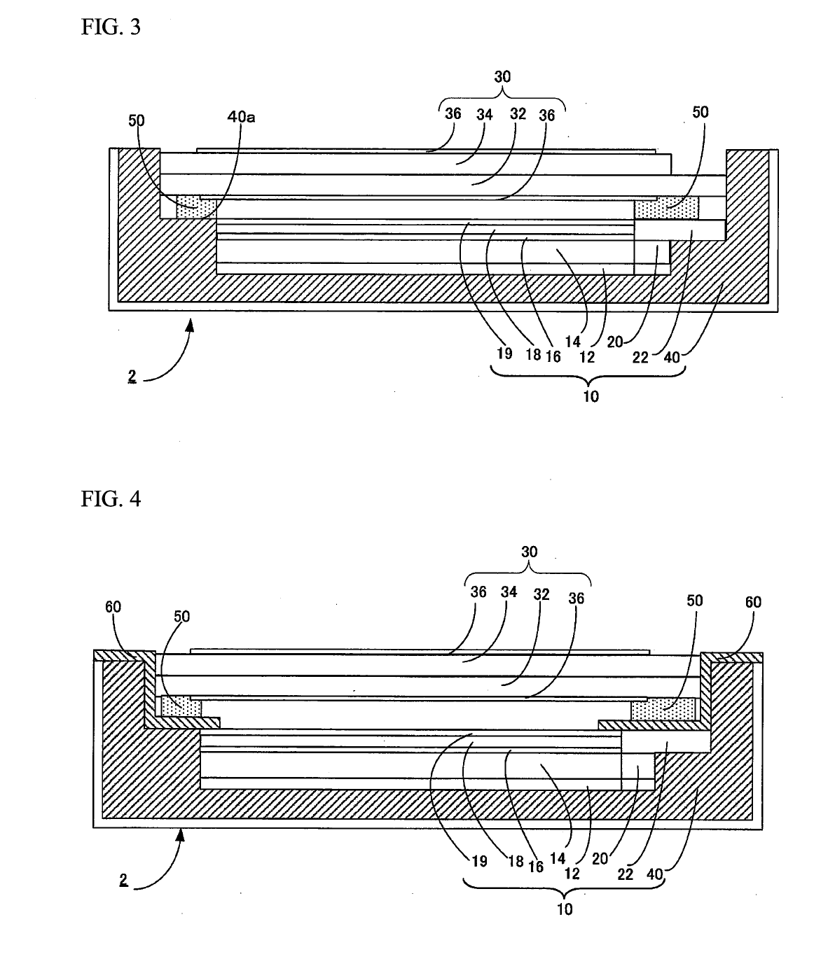

Next, referring to FIGS. 3 to 9, a liquid crystal type display module is taken as an example in the description of other embodiments of the configuration of the display module according to the invention. In the embodiments shown in FIGS. 3 to 7, a bezel 40 is provided as one of the components of the back light unit 10, and individual sheet members constituting the back light unit 10 are accommodated in the bezel 40. Further, the outer edge portion of the bezel 50 extends up to above the liquid crystal panel 30, so that the liquid crystal panel 30 is also accommodated in the bezel 40.

### <Description of the First Embodiment of the Liquid Crystal Type Display Module>

The first embodiment of the liquid crystal type display module 2 according to the invention will be described referring to FIG. 3.

First, the configuration of the back light unit 10 will be described. A reflective sheet 12, a light guide plate sheet 14, a bottom diffusion sheet 16, a prism sheet 18, and an upper diffusion sheet 19 are accommodated in the recess of the bezel 40 in order from the bottom portion of the bezel 40. An LED 22 is attached to the side portion of the light guide plate sheet 14, and a flexible printed circuit board (FPC) 22 electrically connected to the LED 22 is disposed on the upper portion of the LED 22.

The configuration of the liquid crystal panel 30 will be described. A TFT substrate 32 and a color filter substrate 34 are connected via a sealant (not shown), and polarizing plates 36 are adhered to the exterior of the TFT substrate 32 and the color filter substrate 34, respectively.

The TFT substrate 32, not illustrated, has a glass substrate with the polarizing plate 36 adhered to the bottom side thereof, a TFT/transparent electrode, an alignment film, a liquid crystal region, an alignment film, and a transparent electrode in order from the back light side (bottom side in the diagram). Trichromatic color filters are disposed on the color filter substrate 34, adhered to the TFT substrate 32 via the sealant, pixel by pixel.

In this embodiment, the adhesive layer 50 is formed between a connecting surface 40a of the bezel 40 and the bottom surface of the liquid crystal panel 30 (specifically the bottom peripheral region of the TFT substrate 32) except for the region where the flexible printed circuit board 22 is disposed.

According to the embodiment, the individual components of the back light unit 10, and the liquid crystal panel 30 are inserted in the recess of the bezel 40 from the same direction (from above) at manufacturing the display module 2. In forming the back light unit 10, especially, it is necessary to insert the reflective sheet 12, the light guide plate sheet 14, the bottom diffusion sheet 16, the prism sheet 18, and the upper diffusion sheet 19 into the recess of the bezel 40 in order. In this case, if the size of the sheets is made smaller in the order of insertion, parts of the previously inserted sheets can be visually confirmed. This can prevent improper insertion of sheets (missing of insertion) at the time of manufacture.

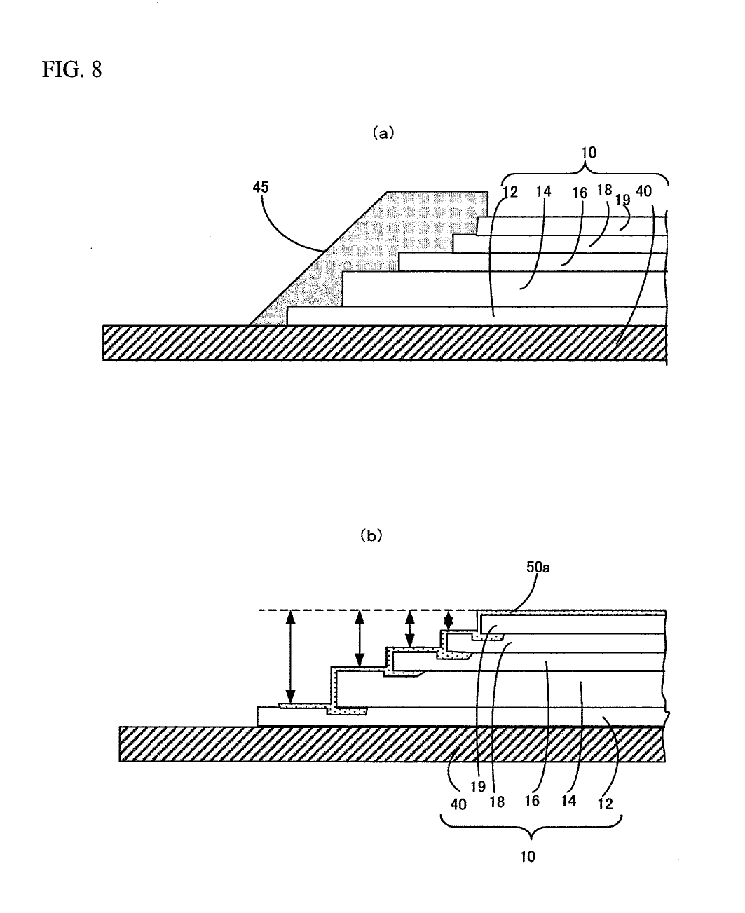

At this time, there arises no problem in forming the adhesive layer 50 on the connecting surface 40a of the bezel 40 (see left-hand side in FIG. 3), but the following problems arise in the case of, for example, directly forming the adhesive layer 50 on the sheet which constitutes the back light unit 10, especially, on a stepped portion where the underlying sheet is partially exposed as shown in FIG. 8.

As shown in FIG. 8A, the sheets 12-19 whose sizes are made smaller in the order of insertion can be fixed at predetermined positions by using a stepped stopper (claw part) 45. When a photo-curable adhesive material composition is applied to the stepped region where the underlying sheet is partially exposed, as shown in FIG. 8B, the defect such that the liquefied photo-curable adhesive material composition 50a soaks between the individual sheets due to capillarity occurs. Further, the spreading spots of the photo-curable adhesive material composition 50a are produced between the region covered with the stopper 45, and the other regions. Furthermore, the stepped shape of the sheet prevents the top surface of the applied photo-curable adhesive material composition 50a from having a uniform height (see the arrow), thereby raising the problem such that the strength of adhesion of both components becomes weaker and the sealing property becomes lower.

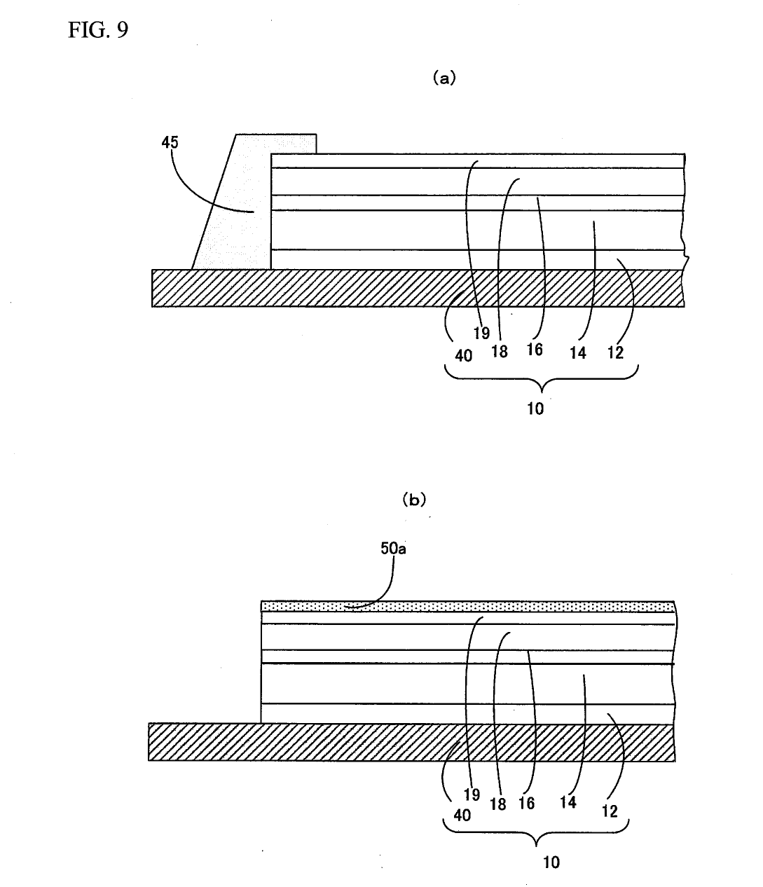

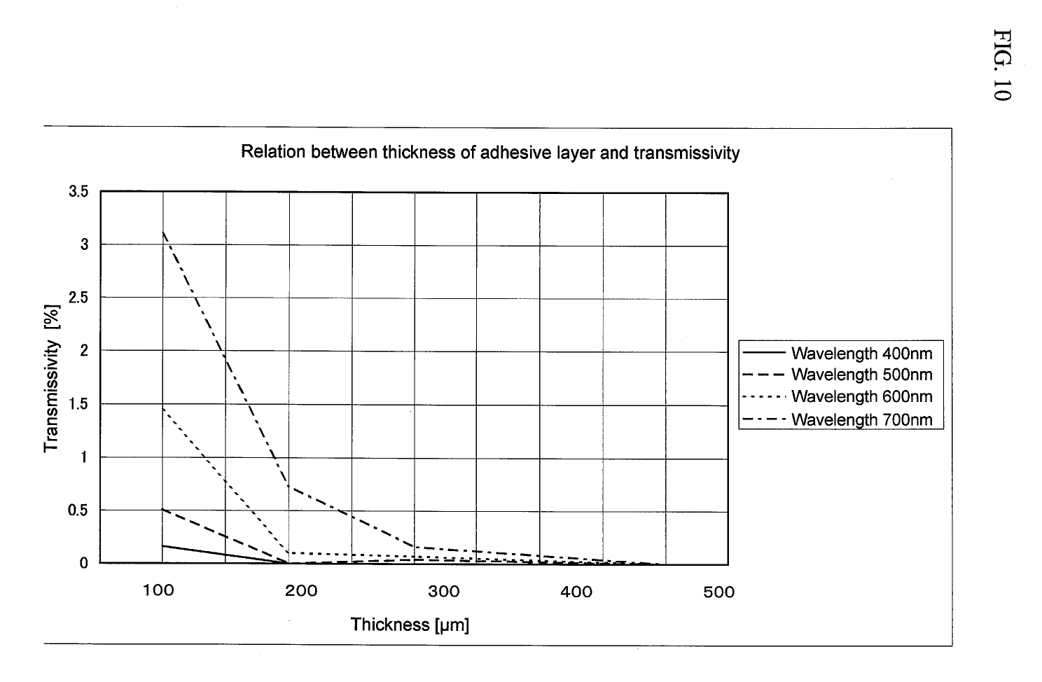

To cope with this problem, in case of applying the photo-curable adhesive material composition 50a to the sheet portions constituting the back light unit 10, it is preferable to make the sizes of the individual sheets 12-19 the same as shown in FIG. 9A, and apply the photo-curable adhesive material composition 50a to the peripheral region of the topmost sheet (upper diffusion sheet 19) as shown in FIG. 9B.

### <Description of the Second Embodiment of the Liquid Crystal Type Display Module>

Next, the second embodiment of the liquid crystal type display module according to the invention will be described referring to FIG. 4.

This embodiment also has a configuration similar to that of the above-mentioned first embodiment, so that only those which are different from the first embodiment will be described.

This embodiment differs from the first embodiment in the point that an upper bezel 60 is disposed on the diffusion sheet 19 which is located topmost among the sheets which constitute the back light unit 10, and the liquid crystal panel 30 is disposed on the upper bezel 60. The adhesive layer 50 is formed between the top surface of the upper bezel 60 and the bottom surface of the liquid crystal panel 30.

The individual sheets 12-19 which constitute the back light unit 10 can be fixed certainly by the upper bezel 60, and the entire adhesive layers 50 can be formed on the upper bezel 60, which differs from the first embodiment in which a part of the adhesive layer 50 is formed on the flexible printed circuit board 22. Therefore, the adhesive layer 50 can be supported on the uniform surface, so that both units 10 and 30 can be connected more certainly, thereby forming a more reliable sealing structure.

### <Description of the Third Embodiment of the Liquid Crystal Type Display Module>

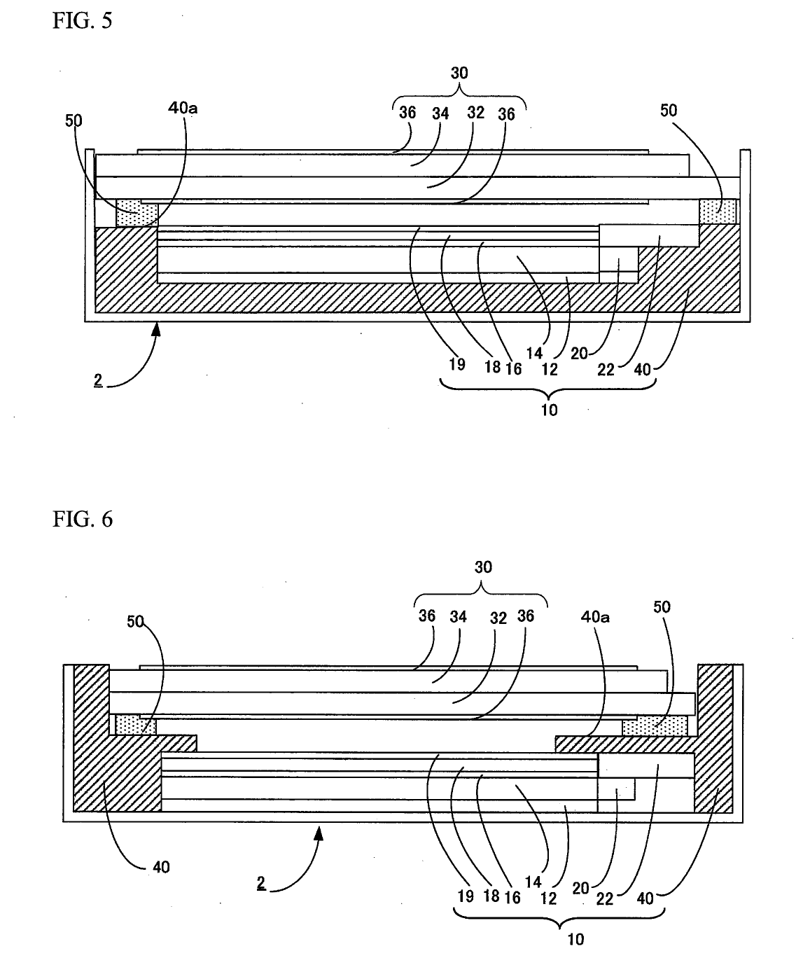

Next, the third embodiment of the liquid crystal type display module according to the invention will be described referring to FIG. 5.

This embodiment also has a configuration similar to that of the above-mentioned first embodiment, so that only those which are different from the first embodiment will be described.

In this embodiment, the liquid crystal panel 30 extends to the outer edge of the bezel 40, and the adhesive layer 50 is formed between the connecting surface 40a of the bezel 40, and the bottom surface of the liquid crystal panel 30. Therefore, the adhesive layer 50 can be supported on the uniform surface, so that both units can be connected more certainly, thereby forming a more reliable sealing structure.

### Description of the Fourth Embodiment of the Liquid Crystal Type Display Module

Next, the fourth embodiment of the liquid crystal type display module according to the invention will be described referring to FIG. 6. According to this embodiment, in manufacturing the display module 2, the individual sheets 12-19 which constitute the back light unit 10, and the liquid crystal panel 30 are inserted into the opening of the bezel 40 from different directions. That is, the individual sheets 12-19 constituting the back light unit 10 are inserted from the lower side of the diagram, and the liquid crystal panel 30 is inserted from the upper side in the diagram, thereby assembling the display module 2.

To form the back light unit 10, the reflective sheet 12, the light guide plate 14, the bottom diffusion sheet 16, the prism sheet 18, and the upper diffusion sheet 19 are inserted into the opening of the bezel 40 in order, in which case, if the sizes of the sheets are made smaller in the order of insertion, a part of the previously inserted sheet can be visually confirmed from above as mentioned above. In this case, since the adhesive layer 50 can be formed on the connecting surface 40a of the bezel 40, a problem such that the photo-curable adhesive material composition 50a soaks between the individual sheets does not arise.

### Description of the Fifth Embodiment of the Liquid Crystal Type Display Module

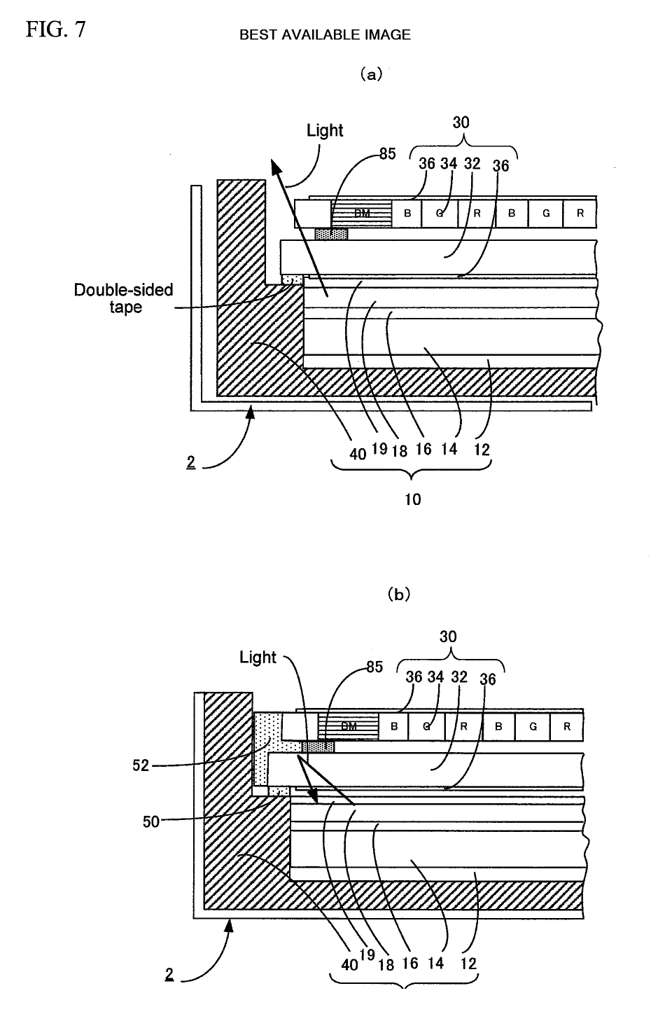

Next, the fifth embodiment of the liquid crystal type display module according to the invention will be described referring to FIG. 7. FIG. 7 shows the configuration of the color filter substrate 34 of the liquid crystal panel 30, and the state of adhesion of the TFT substrate 32 and the color filter substrate 34 in detail.

The trichromatic color filters of blue (B), green (G) and red (R) are disposed on the TFT substrate 34 pixel by pixel, with a black matrix (BM) disposed at the peripheral portion (frame part) thereof. A sealant 85 is adhered to the bottom surface of the frame part where the black matrix is arranged, and the top surface of TFT substrate 32 is adhered to the bottom surface of the sealant 85.

FIG. 7A shows the conventional configuration of such a display module 2, and FIG. 7B shows the configuration of this embodiment.

The conventional configuration as shown in FIG. 7A brings about the problem of light leakage such that, as indicated by the arrow, an illuminated light produced by the back light unit 10 passes along the outside of the black matrix deviating from the display surface, and goes out, thereby arising the problem of the light leaking emitted to the exterior (see the arrow in FIG. 7A). To cope with this problem, as shown in FIG. 7B, a light shielding layer 52 which is obtained by curing the photo-curable adhesive material composition is also formed in the outer peripheral region of the liquid crystal panel 30. For a more detailed description, the light shielding layer 52 is formed outside the TFT substrate 32, outside the color filter substrate 34, and in the outer peripheral region between the TFT substrate 32 and the color filter substrate 34.

This light shielding layer 52 can prevent occurrence of light leakage from the back light unit 10, as indicated by the arrow in FIG. 7B. Although the light shielding layer 52 and the adhesive layer 50 which connects the back light unit 10 and the liquid crystal panel 30 are individually formed in the embodiment shown in FIG. 7B, the light shielding layer 52 and the adhesive layer 50 may be arranged so as to contact each other, so that the layers can be formed substantially integral with the adhesive strength of both layers.

### Description of Test Examples

Next, samples of the photo-curable adhesive resin composition were actually produced, and subjected to the following tests.

### <Description of Test 1>

First, test 1 was conducted to examine the relation between the depth and light shielding property of the adhesive layer made of a photo-curable adhesive resin composition.

### <Preparation of Test Samples>>

First, a reflection material and a light absorbing material were added to the photo-curable adhesive resin composition to produce a liquefied photo-curable adhesive resin composition having the compositions as given below.

A sample solution of a photo-curable adhesive resin composition was prepared by adding 0.3 part of black pigment NBD-0744 (produced by Nikko Bics Co., Ltd.) as a light absorbing material, and 15 parts of alumina filler AO-902H (produced by Admatechs, Co., Ltd.) as a light reflecting material to a photo-curable adhesive resin composition acquired by mixing 60 parts of UN5500 (produced by Negami Chemical Industrial Co., Ltd), 10 parts of HO (2-HEMA produced by Kyoeisha Co., Ltd.), 1.4 parts of LA (Laurylacrylate produced by Kyoeisha Co., Ltd.), and 3 parts of photopolymerization initiator IRGACURE 500 (1-hydroxy-cyclohexyl-phenyl-ketone (50)/benzophenone (50) produced by Ciba Japan, Inc.) as a photo-curable resin composition, and 60 parts of K140 (produced by Fudow Co., Ltd.) as a tackifier.

Next, the prepared sample solution of the photo-curable adhesive resin composition was applied to the substrate using the dispenser to prepare test samples respectively having thicknesses of 50 μm, 100 μm, 200 μm, 300 μm, and 500 μm. With regard to the films with the thickness of 100 μm or greater, the test samples were prepared by laminating films of 100 μm one on another.

### <<Light Irradiation Process>>

Next, the prepared test samples were irradiated with ultraviolet kights under the following conditions to cure the photo-curable adhesive resin compositions, thereby forming adhesive layers.
Light irradiation lamp: metal halide lamp
Peak intensity: 300 mW/cm² (at 365 nm)
Irradiation time: 10 seconds

### <<Measurement of the Transmissivity of Light>>

The samples of the adhesive layer having thicknesses of 50 μm, 100 μm, 200 μm, 300 μm, and 500 μm were irradiated with lights with wavelengths of 300 nm (ultraviolet range), 400 nm (ultraviolet/visible light range), 500 nm (visible light range), 600 nm (visible light range), 700 nm (visible light range), and 800 nm (visible light/infrared range) under the following condition, and the transmissivity of each sample was measured.
Measuring condition: measured by U-best V-570 manufactured by JASCO

### <<Test Results>>

The results of the above test on the thicknesses of the adhesive layers and the light transmissivities with respect to light of each wavelength were obtained.

TABLE 1
The relation between the thicknesses of the adhesive layers and
the transmissivities (%) with respect to light of each wavelength

[%]

| thickness | | | | | |
|---|---|---|---|---|---|
| wavelength | 50 μm | 100 μm | 200 μm | 300 μm | 500 μm |
| 300 nm | 1.60 | 0.00 | 0.00 | 0.00 | 0.00 |
| 400 nm | 8.50 | 0.16 | 0.00 | 0.00 | 0.00 |
| 500 nm | 16.60 | 0.51 | 0.00 | 0.04 | 0.00 |
| 600 nm | 25.20 | 1.44 | 0.10 | 0.07 | 0.00 |
| 700 nm | 33.20 | 3.10 | 0.73 | 0.16 | 0.00 |
| 800 nm | 40.30 | 5.20 | 1.60 | 0.40 | 0.05 |

(Table 1)
(Notes: the transmissivity of 0.00% in the Table 1 means that the measurement taken by the measuring device was 0.)

FIG. 10 shows a graph which shows the relation between the depths of the adhesive layers (excluding 50 μm) and the transmissivities for lights of 400 to 700 nm which is the practically main wavelength range with regard to the relation of the depths of the adhesive layers and transmissivities for the lights of the aforementioned wavelengths.

Next, the following tables shows the test results expressed in terms of the OD value.

TABLE 2
The relation between the film thicknesses and the
OD values with respect to light of each wavelength

| thickness | | | | | |
|---|---|---|---|---|---|
| wavelength | 50 μm | 100 μm | 200 μm | 300 μm | 500 μm |
| 300 nm | 1.80 | ∞ | ∞ | ∞ | ∞ |
| 400 nm | 1.07 | 2.80 | ∞ | ∞ | ∞ |
| 500 nm | 0.78 | 2.29 | ∞ | 3.40 | ∞ |
| 600 nm | 0.60 | 1.84 | 3.00 | 3.15 | ∞ |
| 700 nm | 0.48 | 1.51 | 2.14 | 2.80 | ∞ |
| 800 nm | 0.39 | 1.28 | 1.80 | 2.40 | ∞ |

(Table 2)
(Notes: the OD value of ∞ in the Table 2 means the OD value corresponding to the transmissivity of 0.00% in the Table 1.)

It was proved from the foregoing test results that when the depth of the photo-curable adhesive resin composition to be applied was set to 100 μm or less, ultraviolet lights or visible light transmitted. It was proved that when using a visible light, the light was transmitted through the layer even with a thickness of 200 μm or greater, and when using a visible light with a long wavelength, such as red light, the light was transmitted through the layer even with a thickness of 300 μm or greater.

It is to be noted that the maximum thickness in which the photo-curable adhesive resin composition is cured will be calculated by further adding 200 μm or so to the aforementioned maximum thickness which a light transmits (e.g., about 300 μm). This is originated from the propagation of the radical reaction of the photo-curable adhesive resin composition.

It became clear that it is preferable to take the depth of 300 μm or greater in order to substantially shield visible light with a viscous layer, and, especially, it is preferable to take the depth of 500 μm or greater in order to acquire sufficient light shielding against visible lights of the full wavelength range.

### <Description of Test 2>

Next, test 2 was conducted to examine the relation between the amount of the light absorbing material to be added to the photo-curable adhesive resin composition and the transmissivity or the reflectance.

### <<Preparation of Test Samples>>

First, a reflection material and a light absorbing material were added to the photo-curable adhesive resin composition to produce a liquefied photo-curable adhesive resin composition having the compositions as given below.

A sample solution of a photo-curable adhesive resin composition was prepared by adding 10 parts of alumina filler AO-902H (produced by Admatechs, Co., Ltd.) as a light reflecting material and 0.2 part of black pigment NBD-0744 (produced by Nikko Bics Co., Ltd.) as a light absorbing material to a photo-curable adhesive resin composition acquired by mixing 60 parts of UN5500 (produced by Negami Chemical Industrial Co., Ltd), 10 parts of HO (2-HEMA produced by Kyoeisha Co., Ltd.), 1.4 parts of LA (Laurylacrylate produced by Kyoeisha Co., Ltd.), and 3 parts of photopolymerization initiator IRGACURE 500 (1-hydroxy-cyclohexyl-phenyl-ketone (50)/benzophenone (50) produced by Ciba Japan, Inc.) as a photo-curable resin composition, and 60 parts of K140 (produced by Fudow Co., Ltd.) as a tackifier. At the same time, a sample solution of a photo-curable adhesive resin composition without adding the black pigment (others were identical) was prepared.

Next, the prepared two types of sample solutions of the photo-curable adhesive resin composition were respectively applied to separate substrates using the dispenser to prepare test samples having thicknesses of 50 μm. In this case, the test samples were prepared by laminating films of 100 μm one on another.

### <<Light Irradiation>>

Next, the prepared two test samples were irradiated with ultraviolet rays under the following conditions to cure the photo-curable adhesive resin compositions, thereby forming adhesive layers.
Light irradiation lamp: metal halide lamp
Peak intensity: 300 mW/cm² (at 365 nm)
Irradiation time: 10 seconds

### <<Measurement of the Transmissivity and Reflectance of Light>>

The two test samples prepared in the above manner were irradiated with lights with wavelengths of 300 nm (ultraviolet range), 400 nm (ultraviolet/visible light range), 500 nm (visible light range), 600 nm (visible light range), 700 nm (visible light range), and 800 nm (visible light/infrared range) under the following condition, and the transmissivity and reflectance of each sample were measured.
Measuring condition: measured by U-best V-570 manufactured by JASCO

### <<Test Results>>

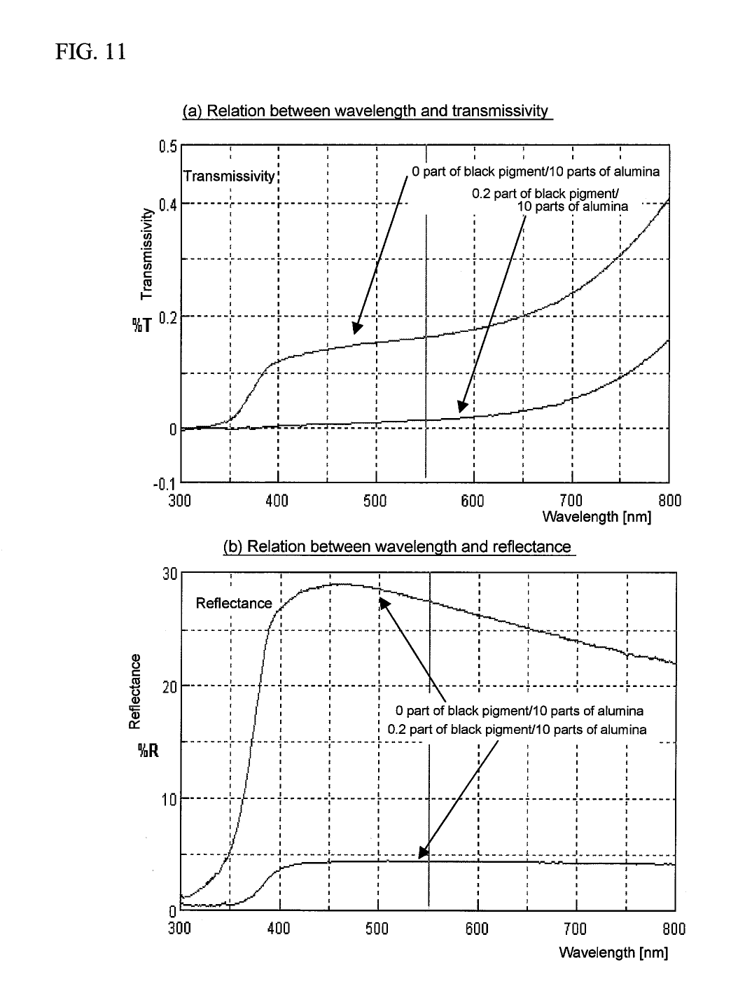

Through the above test, the relation between the wavelength and transmissivity of light as shown by a graph in FIG. 11A and the relation between the wavelength and reflectance of light as shown by a graph in FIG. 11B were obtained for the sample of the adhesive layer made of a photo-curable adhesive resin composition to which a light absorbing material added and the sample of the adhesive layer made of a photo-curable adhesive resin composition to which no light absorbing material is added.

It became clear from comparison of the graphs in FIGS. 11A and 11B with each other that addition of the light absorbing material reduced the transmissivity by a certain degree (i.e., increased the light shielding), and the reflectance was reduced significantly.

As mentioned above, when the reflectance of the adhesive layer is high, the light shielding which prevents back light from leaking outside can be guaranteed, but it is preferable to suppress the reflectance while securing the light shielding since there is a possibility that the reflection inside the back light unit may occur to interfere with uniform light illumination.

It was proved from the test results that high light shielding effect (low transmissivity) and low reflectance were achieved at the same time by adequately adding the light absorbing material to the photo-curable adhesive resin composition.

### <Description of Test 3>

Next, test 3 was conducted to examine the relation between the amount of the light absorbing material to be added to the photo-curable adhesive resin composition and the maximum depth of the photo-curable adhesive resin composition which permits the composition to be cured with light irradiation. As given below, samples with the fixed amount of the light reflecting material (alumina) to be added to the photo-curable adhesive resin composition and the amount of the light absorbing material (black pigment) being variable were prepared and irradiated with a light, and the maximum depth which permits curing was measured.

### <<Preparation of Test Samples>>

First, a liquefied photo-curable adhesive resin composition having the compositions as given below was prepared.

Seven types of sample solutions of a photo-curable adhesive resin composition were prepared by adding 10 parts of alumina filler AO-902H (produced by Admatechs, Co., Ltd.) as a light reflecting material to a photo-curable adhesive resin composition acquired by mixing 60 parts of UN5500 (produced by Negami Chemical Industrial Co., Ltd), 10 parts of HO (2-HEMA produced by Kyoeisha Co., Ltd.), 1.4 parts of LA (Laurylacrylate produced by Kyoeisha Co., Ltd.), and 3 parts of photopolymerization initiator IRGACURE 500 (1-hydroxy-cyclohexyl-phenyl-ketone (50)/benzophenone (50) produced by Ciba Japan, Inc.) as a photo-curable resin composition, and 60 parts of K140 (produced by Fudow Co., Ltd.) as a tackifier, and then mixing 0 part, 0.1 part, 0.2 part, 0.5 part, 1 part, 3 parts and 5 parts of black pigment NBD-0744 (produced by Nikko Bics Co., Ltd.) as a light absorbing material.

### <<Light Irradiation and Measurement of the Curable Depth>>

Next, the prepared seven test samples were irradiated with ultraviolet lights under the following conditions, and the maximum depths in which the photo-curable adhesive resin composition is cured were measured.
Light irradiation lamp: metal halide lamp
Peak intensity: 300 mW/cm² (at 365 nm)

### <<Test Results>>

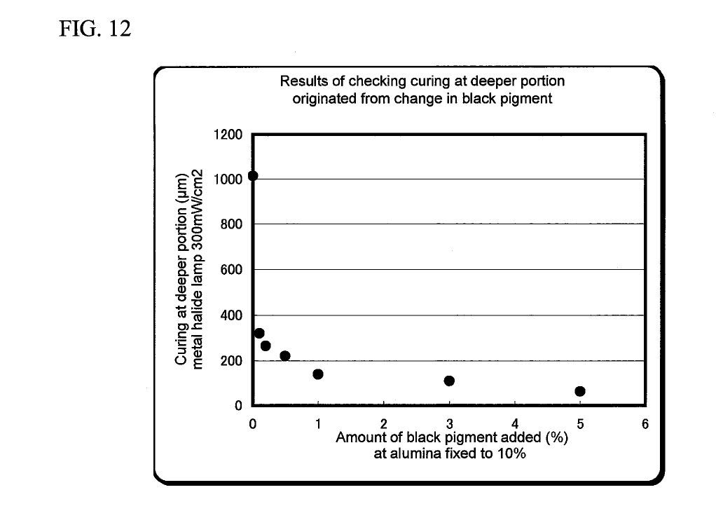

FIG. 12 shows the maximum curable depths of the individual samples measured in the above manner. The horizontal axis in FIG. 12 represents the amount of the black pigment added by weight %, and the vertical axis represents the maximum curable depth by μm. As shown in FIG. 12, the relation between the added amount of the black pigment and the maximum curable depth of the photo-curable adhesive resin composition became clear.

### Description of Other Embodiments of the Invention

Embodiments of the display module according to the invention and the method of manufacturing this display module are not restricted to the above-described embodiments, and other various embodiments are encompassed in the invention.

### [Description of Reference Numerals]

2 Display module
2a Interior
10 Back light unit
12 Reflective sheet
14 Light guide plate
16 Bottom diffusion sheet
18 Prism sheet
19 Upper part diffusion sheet
20 LED
22 Flexible printed circuit board (FPC)
30 Liquid crystal panel
32 TFT substrate
34 Color filter substrate
36 Polarizing plate
40 Bezel
40a Connecting surface
45 Stopper (claw part)
50 Adhesive layer
50a Liquefied photo-curable adhesive resin composition
52 Light shielding layer
60 Upper bezel
70 Dispenser device
80 Ultraviolet-ray irradiating device
85 Sealant

1. A display module comprising:
a first component;
a second component; and
an adhesive layer formed between the first component and second component and in an outer peripheral area of both components, wherein the first component and second component are connected by the adhesive strength of the adhesive layer, and a closed space is formed by the first component, the second component and the adhesive layer, wherein
the adhesive layer is made of a photo-curable adhesive resin composition which is cured and activates adhesiveness when irradiated with a light and sustains the adhesiveness, and
the adhesive layer has such a thickness as to have translucency which allows the photo-curable adhesive resin composition to be cured with irradiation of a light from the direction between the first component and second component, and has such a width as to have a substantial light shielding property against transmission of a light in the adhesive layer in the direction between the closed space and an exterior of the display module.

2. The display module according to claim 1, wherein the first component and the second component do not have translucency enough to cure the uncured photo-curable adhesive resin composition existing between the first component and the second component with irradiation of a light from outside the components.

3. The display module according to claim 1, wherein the adhesive layer has elasticity, and the closed space is sealed from outside by the adhesive layer.

4. The display module according to claim 1, wherein having the substantial light shielding property means having an optical density of 3 or more in terms of an OD (Optical Density) value.

5. The display module according to claim 4, wherein reflectance of the adhesive layer with respect to a light which travels in the direction between the closed space and the exterior of the display module is 0.5% or less.

6. The display module according to claim 1, wherein the first component is a back light unit, and the second component is a liquid crystal panel.

7. The display module according to claim 6, wherein the back light unit includes a bezel which accommodates a sheet member constituting the back light unit, and the adhesive layer is formed between a connecting surface provided on the bezel, and the liquid crystal panel.

8. The display module according to claim 7, wherein an outer edge of the bezel extends above the liquid crystal panel, and the liquid crystal panel is accommodated in the bezel.

9. The display module according to claim 6, wherein a light shielding layer made of the photo-curable adhesive resin composition is also formed on an outer peripheral area of the liquid crystal panel.

10. A method of manufacturing a display module comprising:
a first step of applying an uncured photo-curable adhesive resin composition, which is cured and activates adhesiveness when irradiated with a light and sustains the adhesiveness, to an outer peripheral area of one component;
a second step of irradiating a light onto the applied photo-curable adhesive resin composition to cure the photo-curable resin composition to form an adhesive layer having an adhesive strength; and
a third step of connecting another component to the side of the one component where the adhesive layer is formed, after irradiation of the light, thereby assembling the display module.
